(19) United States
(12) Patent Application Publication
(10) Pub. No.: US 2026/0194316 A1
(43) Pub. Date: Jul. 9, 2026

(54) METHOD FOR OPERATING A HEAT EXCHANGER AND SYSTEM COMPRISING A HEAT EXCHANGER

(71) Applicant: GÜNTNER GMBH & CO. KG, Fürstenfeldbruck (DE)

(72) Inventor: Jörg KÖCHER, Utting (DE)

(21) Appl. No.: 18/863,901

(22) PCT Filed: May 25, 2023
(86) PCT No.: PCT/EP2023/064102

§ 371 Date: Nov. 7, 2024

(30) Foreign Application Priority Data
May 27, 2022 (DE) 10 2022 113 410.5

(51) Int. Cl. F28F 27/00; F28F 17/00; F28G 15/00

(52) U.S. Cl. CPC F28F 27/00; F28G 15/003; G06N 3/043; F28F 17/00

(57) ABSTRACT

A method for operating a heat exchanger includes the following steps: operating a heat exchanger; monitoring the heat exchanger by at least one monitoring device, such as a sensor, a device for imaging or the like; detecting a degree of icing and/or degree of soiling of the heat exchanger and determining a thawing time and/or cleaning time for the heat exchanger by evaluating data of the at least one monitoring device; wherein the evaluation of the data is AI-based. An AI-based classifier has two or more classes, which define a degree of icing and/or degree of soiling, and wherein the AI-based classifier assigns the data of the at least one monitoring device to one of the classes.

### CROSS-REFERENCE TO RELATED APPLICATIONS

This application is a 35 U.S.C. § 371 National Stage patent application of PCT/EP2023/064102, filed on 25 May 2023, which claims the benefit of German patent application 10 2022 113 410.5, filed on 27 May 2022, the disclosures of which are incorporated herein by reference in their entirety.

### TECHNICAL FIELD

The present disclosure relates to a method for operating a heat exchanger and a system comprising a heat exchanger.

### BACKGROUND

Heat exchangers are used to remove heat from a system to be cooled or to introduce heat into a system to be heated. In the field of refrigeration technology, heat exchangers are used to remove heat from a volume to be cooled by transferring a cooling medium from the liquid to the gaseous phase, wherein the heat exchanger is used as an evaporator. Similarly, a heat exchanger can be used in the field of heating technology to absorb ambient heat from the outside air in order to provide heat for a building to be heated in conjunction with a heat pump. Conversely, such a heat exchanger can also be used as a condenser or recooler to release heat into the environment.

Regardless of the particular application, it is crucial for the reliable and fault-free functioning of the heat exchanger that heat transfer between the heat exchanger and its surroundings is not restricted by interference that isolates the heat exchanger from its surroundings. Such interfering influences are, for example, contamination or icing of the heat exchanger, which can accumulate between the fins or fin packs of the heat exchanger.

Heat exchangers often have fins or fin packs in order to provide the largest possible surface area available for heat transfer while keeping the size small. In the practical operation of such a heat exchanger, moisture from the surroundings of the fins may condense on their surfaces, causing these surfaces and the spaces between the fins to ice up. Due to the insulating effect of this icing, the heat transfer between the environment of the heat exchanger and its fins or the corresponding liquid inside the heat exchanger is impaired. In addition, the air flow through the heat exchanger is impaired, which increases the pressure loss and reducing the performance as less air flows through the heat exchanger. In this state, the heat exchanger may no longer provide the required cooling capacity or heat output. This can lead to the destruction of the cooled goods or to the failure of a system to be cooled. Furthermore, icing can damage the components of the heat exchanger.

In order to remove the icing, it is known to defrost the heat exchanger using a heating device. Such defrosting should be carried out as efficiently as possible. If defrosting is carried out too frequently or over too long a period, an unnecessarily large amount of heating energy is introduced into a volume that is to be cooled, for example, which then has to be removed with the aid of the heat exchanger in order to maintain or set the intended cooling temperature. If defrosting is carried out too infrequently or for too short a period, defrosting is not effective and the functionality of the system in question is impaired. Well-known methods of defrosting include electric defrosting, hot gas defrosting, hot brine defrosting and water or air defrosting.

For example, document CN107091548A describes a defrosting process that uses a camera and AI-based image analysis.

### SUMMARY

Against this background, the present disclosure is based on the technical problem of providing a method for operating a heat exchanger and a system comprising a heat exchanger which, in particular, enable efficient defrosting and reliable operation of the heat exchanger.

According to a first aspect, the disclosure relates to a method comprising the steps of: operating a heat exchanger; monitoring the heat exchanger by means of at least one monitoring device, such as a sensor, a device for imaging or the like; detecting a degree of icing and/or a degree of soiling of the heat exchanger and determining a defrosting time and/or a cleaning time of the heat exchanger by evaluating data from the at least one monitoring device; wherein the evaluation of the data is AI-based, wherein an AI-based classifier has two or more classes which define a degree of icing and/or degree of soiling and wherein the AI-based classifier assigns the data of the at least one monitoring device to one of the classes,

The AI-based classifier could be used to precisely determine a defrosting and/or cleaning time so that premature or delayed cleaning and/or defrosting can be avoided.

When the abbreviation “AI” is used in this document, it stands for “artificial intelligence” and is synonymous with the related topics of “machine learning” and “deep learning”.

The device for imaging can be a camera. The device for imaging can be an infrared camera. The device for imaging can be a thermal imaging camera. The device for Imaging may be configured to produce photographic images in the visible wavelength range. The device for imaging can be set up to generate photographic images in the non-visible wavelength range. The device for imaging can be set up to generate thermal images.

When reference is made herein to a visible wavelength range, this relates to wavelengths that are visible to humans. When reference is made herein to a non-visible wavelength range, this relates to wavelengths that are not visible to humans.

It may be provided that in addition to the AI-based determination of a cleaning time and/or a defrosting time, it may also be possible to control a defrosting process and/or a cleaning process using AI.

According to one design of the method, it may be provided that the classes are numbered in ascending order to define an increasing degree of icing and/or soiling and/or to define an increasing defrosting and/or cleaning requirement, wherein a class is defined as a threshold for the heat exchanger, upon reaching or exceeding which a defrosting time and/or a cleaning time is defined. For example, up to 10 classes or up to 20 classes or up to 40 classes can be defined.

According to one design of the method, it may be provided that fewer than 10 classes are provided, for example three, four or five classes are provided.

According to one design of the method, exactly five classes are provided.

It may be provided that the number of classes are odd.

Alternatively or additionally, it may be provided that the classes are assigned to groups, wherein a first group contains classes for whose degree of icing and/or degree of soiling there is a defrosting and/or cleaning requirement and wherein the second group contains classes for whose degree of icing and/or degree of soiling there is no defrosting and/or cleaning requirement. Each group contains at least one class. The number of classes per group can be the same or different. For example, if 10 classes are provided, it is possible that 5 of the 10 classes are assigned to the first group and 5 of the 10 classes are assigned to the second group. If, for example, 11 classes are provided, it may be provided that 7 of the 11 classes are assigned to the first group and 4 of the 11 classes are assigned to the second group. If, for example, 4 classes are provided, it may be provided that one of the 4 classes is assigned to the first group and 3 of the 4 classes are assigned to the second group. If, for example, 6 classes are provided, it may be provided that 3 of the 6 classes are assigned to the first group and 3 of the 6 classes are assigned to the second group.

According to one design of the method, exactly five classes are provided, wherein three classes are assigned to the first group and two classes are assigned to the second group. A small number of classes simplifies the manual classification of training data.

In particular, it may be provided that the first group has more classes than the second group.

It may be provided that each of the groups has fewer than five classes.

Overall, the detection of a degree of icing and/or a degree of soiling of the heat exchanger and a necessary or unnecessary defrosting and/or cleaning to be derived from this can be mapped as a classification problem by means of an AI, wherein a mapping function is generated using training data, which uses sensor data or image data to classify a degree of icing and/or a degree of soiling of the heat exchanger as either critical or non-critical, so that cleaning and/or defrosting is started or the heat exchanger can initially continue to be operated without cleaning and/or defrosting. It may be provided that the mapping function is further improved using the image data and sensor data processed during operation, so that it is a “learning” algorithm. In other words, the quality of the mapping function can be improved as the amount of data increases.

When sensor data is referred to in the present case, this involves one or more of the values listed below: temperature data of the environment and/or a refrigerant, pressure of a refrigerant, in particular at an inlet and outlet of the heat exchanger; air pressure, in particular a differential pressure between an ambient pressure and a pressure between a fan and a fin arrangement, wherein, for example, a pressure loss is measured on a side of a fin arrangement facing away from the fan.

According to one design of the method, it may be provided that the AI-based classifier is set up to determine a defrosting time and/or cleaning time for different heat exchangers, wherein the heat exchangers differ from each other in terms of their construction type and/or their operating conditions.

The design types may differ, for example, in terms of the dimensions of the heat exchanger, the number of fans assigned to the heat exchanger, the number of heat exchangers, the power range, the design of the heat exchanger and the like.

The operating conditions may differ, for example, with regard to the ambient temperatures, ambient pressures and ambient humidity to be expected during operation, i.e. in other words with regard to their ambient conditions. The operating conditions may differ, for example, with regard to the area of application, e.g. whether the heat exchanger is used in a cold room for food or in the open environment. The operating conditions can also differ in terms of how many other heat exchangers are additionally arranged adjacent to the heat exchanger in question.

Depending on the construction type and operating conditions, it may therefore be necessary to defrost and/or clean a heat exchanger sooner or later. It may therefore be optionally possible to allow a higher degree of soiling and/or icing for a first heat exchanger, depending on its construction type and operating conditions, than is possible for a second heat exchanger, depending on its construction type and operating conditions.

According to one design of the method, it may be provided that for each of the respective different heat exchangers, depending on its construction type, a class is defined as a respective threshold, upon reaching or exceeding which a defrosting time and/or a cleaning time is defined, wherein the respective threshold is different for at least two of the respective different heat exchangers. In this way, a single AI-based classifier can be used to reliably operate heat exchangers of different construction types under different operating conditions.

Alternatively or additionally, it may be provided that for each of the respective different heat exchangers, the classes are assigned to the first group and to the second group depending on their construction type, wherein the assignment of the classes to the first group and to the second group is different for at least two of the respective different heat exchangers. In this way, a single AI-based classifier can be used to reliably operate heat exchangers of different construction types under different operating conditions.

According to a further design, the method can be characterized by operating a further heat exchanger; monitoring of the further heat exchanger by means of at least one further monitoring device, such as a sensor, a device for imaging or the like; detecting a degree of icing and/or degree of soiling of the further heat exchanger and determining a defrosting time and/or cleaning time of the further heat exchanger by evaluating data from the at least one further monitoring device; wherein the evaluation of the data is AI-based by means of the AI-based classifier, wherein the AI-based classifier assigns the data of the at least one further monitoring device to one of the classes and wherein the defrosting time and/or cleaning time of the heat exchanger for at least one degree of icing and/or degree of soiling is defined differently from the defrosting time and/or cleaning time of the further heat exchanger with essentially the same degree of icing and/or degree of solling. In this way, a single AI-based classifier can be used to reliably operate heat exchangers of different types under different operating conditions.

According to one design of the method, it may be provided that the same database and the same AI-based evaluation are used for both the heat exchanger and the further heat exchanger.

Alternatively or additionally, it may be provided that a plurality of heat exchangers are provided, wherein a defrosting time and/or cleaning time is determined AI-based by means of the AI-based classifier for each of the plurality of heat exchangers depending on its respective construction type and/or its respective operating conditions.

The fact that the same database can be used across devices for two or more heat exchangers means that an extensive database can be built up quickly in order to improve the quality of a mapping function of the AI-based evaluation.

According to one design of the method, manually classified reference data can be used as training data for the AI-based classifier. For this purpose, skilled personnel can, for example, manually classify image data and/or sensor data or data packets consisting of both image data and sensor data. In this way, several people can classify image data and/or sensor data or data packets into classes in order to classify the degree of icing and/or soiling of the heat exchanger in question. This training data can be used to generate an initial mapping function of the classifier, the quality of which can then be improved by additional manually classified image data and/or sensor data or data packets and image data and/or sensor data or data packets classified during automated operation of the classifier.

According to one design of the method, it may be provided that a control device of the heat exchanger is connected to a server, wherein the AI-based classifier and/or a database of the AI-based classifier are stored on the server.

Alternatively or additionally, it may be provided that parts of the database and/or the classifier are stored in a memory device of the control unit. It may be provided that the control device has a computer for operating the classifier.

Alternatively or additionally, it may be provided that the database and/or the classifier are completely stored in the memory device of the control device and the classifier is operated by means of the computer of the control device.

It may be provided that the control device has a wireless or wired data interface for data exchange with a server.

According to one design of the method, it may be provided that two or more heat exchangers are provided, wherein a defrosting time and/or cleaning time is determined AI-based by means of the AI-based classifier for each of the two or more heat exchangers depending on its respective construction type and/or its respective operating conditions, and wherein a defrosting sequence and/or cleaning sequence is determined on the basis of the construction type and/or the operating conditions and/or on the basis of a degree of icing and/or a degree of soiling of a respective heat exchanger of the two or more heat exchangers.

According to one design of the method, it may be provided that the two or more heat exchangers are arranged in a walk-in cold room and defrosting of the heat exchangers takes place essentially one after the other, in particular essentially not simultaneously. If two or more heat exchangers are arranged together within a walk-in cold room, defrosting should preferably not take place simultaneously in order to keep the heat input into the cold room as low as possible and to keep the intended temperature of the cold room as constant as possible even during defrosting.

Alternatively or additionally, it may be provided that a defrosting sequence and/or cleaning sequence of the heat exchangers is carried out by an AI-based determination of a respective class as a threshold for each of the heat exchangers, upon reaching or exceeding which a defrosting time and/or a cleaning time is determined.

If, for example, identical heat exchangers are arranged together in a walk-in cold room and, for each of the heat exchangers, for example, class VI is defined as the threshold at which defrosting is initiated, the threshold for one of the heat exchangers can be lowered from class VI to class IV by means of the AI, for example, in order to defrost this heat exchanger first. The lowering of the threshold can then be repeated for each of the heat exchangers. After defrosting, the threshold of the respective heat exchanger can be reset to the original value.

Alternatively, it may be provided that the thresholds of the heat exchangers can be set differently for each heat exchanger, starting from class VI, so that a heat exchanger is defrosted for a class III degree of icing, a heat exchanger for a class IV degree of icing, a heat exchanger for a class V degree of icing and a heat exchanger for a class VI degree of icing. Here too, the thresholds can be reset after each defrost. In this case, it is possible to start with a different heat exchanger for each defrosting cycle, so that the threshold is lowered to class III alternately for all heat exchangers, so that a different heat exchanger is defrosted first for each cycle.

Alternatively or additionally, it may be provided that a defrosting sequence and/or cleaning sequence of the heat exchangers is carried out by AI-based assignment of a respective class to the first or second group for each of the heat exchangers. From a technical point of view, the assignment of classes to the groups has essentially the same effect that has already been described for setting thresholds.

By assigning classes to groups, it is possible to determine the degree of icing and/or soiling for which defrosting or cleaning is required. If two or more heat exchangers are arranged together in a cooling volume, each of which is based on an identical assignment of the classes to the first group “Defrosting” and the second group “Non defrosting”, the defrosting sequence can be determined by changing the assignment of the classes to the groups for one or more heat exchangers using the AI. After defrosting, the assignment of the classes to the groups can be reset to the original state.

According to a second aspect, the disclosure relates to a system having a device, wherein the device has a heat exchanger with a heating device and/or with a cleaning device, wherein the device comprises a control device and at least one monitoring device, such as a sensor, a device for imaging or the like, for monitoring the heat exchanger, having an AI-based classifier, wherein the control device is set up to perform the following method steps: operating the heat exchanger; monitoring the heat exchanger by means of the at least one monitoring device; detecting a degree of icing and/or degree of soiling of the heat exchanger and determining a defrosting time and/or cleaning time of the heat exchanger by evaluating data from the at least one monitoring device; wherein the evaluation of the data is AI-based, wherein an AI-based classifier has two or more classes that define a degree of icing and/or degree of soiling and wherein the AI-based classifier assigns the data of the at least one monitoring device to one of the classes.

All aspects described above with regard to the method according to the disclosure can apply equally to the device according to the disclosure. Conversely, all aspects relating to the system according to the disclosure can be used in the method according to the disclosure.

According to one design of the system, it may be provided that the AI-based classifier is set up to determine a defrosting time and/or cleaning time for different heat exchangers, wherein the heat exchangers differ from each other in terms of their construction type and/or their operating conditions.

According to one design of the system, it may be provided that the system has a further device, wherein the further device has a further heat exchanger with a further heating device and/or with a further cleaning device, wherein the further device has a further control device and at least one further monitoring device, such as a sensor, a device for imaging or the like, for monitoring the further heat exchanger, wherein the further control device is set up to carry out the following method steps: operating the further heat exchanger; monitoring of the further heat exchanger by means of the at least one further monitoring device; detecting a degree of icing and/or degree of soiling of the further heat exchanger and determining a defrosting time and/or cleaning time of the further heat exchanger by evaluating data from the at least one further monitoring device; wherein the evaluation of the data is AI-based, wherein the AI-based classifier assigns the data of the at least one further monitoring device to one of the classes, wherein both the control device of the heat exchanger of the device and the further control device of the further heat exchanger of the further device are connected to a server, wherein the AI-based classifier and/or a database of the AI-based classifier is stored on the server.

According to one design of the system, it may be provided that the same database and the same AI-based evaluation are used both for the heat exchanger of the device and for the heat exchanger of the further device.

According to one design of the system, it may be provided that the defrosting time and/or cleaning time of the heat exchanger for at least one degree of icing and/or degree of soiling is defined differently from the defrosting time and/or cleaning time of the further heat exchanger for essentially the same degree of icing and/or degree of soiling.

According to one design of the system, it may be provided that manually classified reference data can serve as the basis for the AI-based classifier.

According to one design of the system, it may be provided that a plurality of devices with heat transfer are provided, wherein a defrosting time and/or cleaning time is determined AI-based by means of the AI-based classifier for each of the plurality of devices.

According to one design of the system, it may be provided that the system is set up to carry out a method according to the disclosure for one heat exchanger or for a plurality of heat exchangers.

### BRIEF DESCRIPTION OF THE DRAWINGS

The disclosure is described in more detail below with reference to drawings illustrating exemplary embodiments. They show schematically in each case:

FIG. 1 shows a perspective view of a system according to the disclosure;

FIG. 2 shows a perspective view of the system in FIG. 1 without housing;

FIG. 3 shows the heat exchanger of the system in FIG. 1 with continuous heating rods;

FIG. 4 shows a heat exchanger for a system according to FIG. 1 with non-continuous heating rods;

FIG. 5 shows icing conditions of the heat exchanger from FIG. 3;

FIG. 6 shows a flow chart of a method according to the disclosure;

FIG. 7 shows a system according to the disclosure with several devices and a server;

FIG. 8 shows the system from FIG. 7 in a cold room; and

FIG. 9 shows another system according to the disclosure with several devices and a server.

### DETAILED DESCRIPTION OF THE DRAWINGS

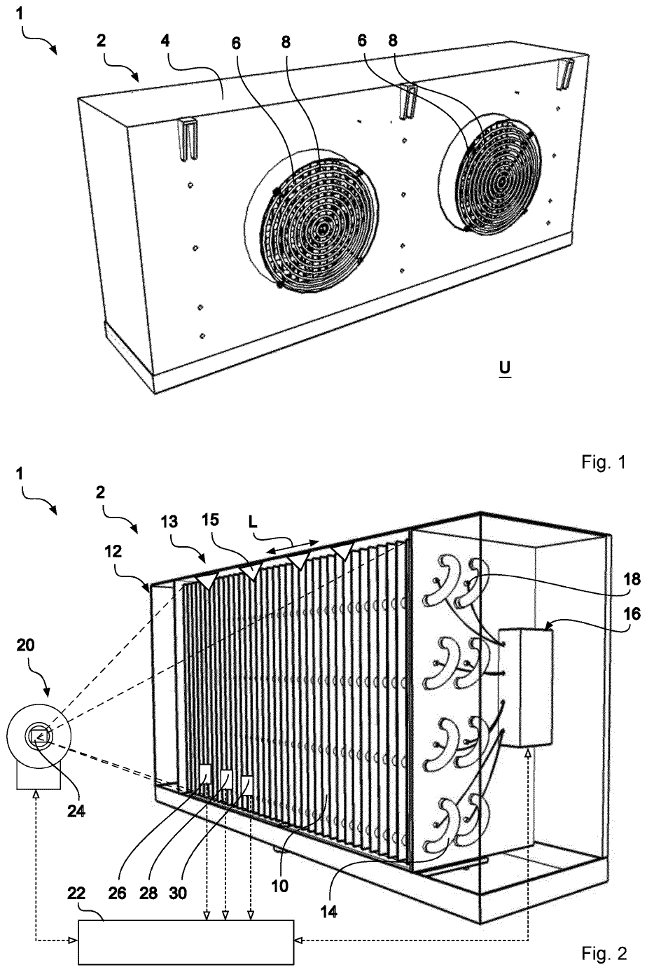

FIG. 1 shows a system 1 according to the disclosure having a device 2. The device 2 is a cooling system 2. The cooling system 2 can be used, for example, to cool a walk-in cooling volume.

The cooling system 2 has a housing 4 that supports protective grilles 6 of fans 8 of the cooling system 2. The fans 8 are used to convey air from an environment U along fins 10 of a heat exchanger 12 of the cooling system 2. The heat exchanger 12 is described below with reference to FIG. 2.

The heat exchanger 12 is located inside the cooling system 2, so that the housing 4 is hidden to illustrate the heat exchanger 12 in FIG. 2. The heat exchanger 12 has a plurality of flat or plate-shaped fins 10 which are lined up essentially parallel to one another along a longitudinal extension L of the heat exchanger 12.

A pipe 14 of the heat exchanger 12, which carries a cooling medium, runs through the fins 10. The fins 10 can also be referred to as cooling fins 10. The cooling fins 10 are connected to the pipe 14 of the heat exchanger 12.

The device 2 has a heating device 16 with heating rods 18 for defrosting the heat exchanger 12. The heating rods 18 also pass through the cooling fins 10 along the longitudinal direction L and are connected to the cooling fins 10.

The device 2 has a cleaning device 13 with cleaning nozzles 15 which spray a cleaning fluid, such as water or the like, onto the fins 10 to remove solling.

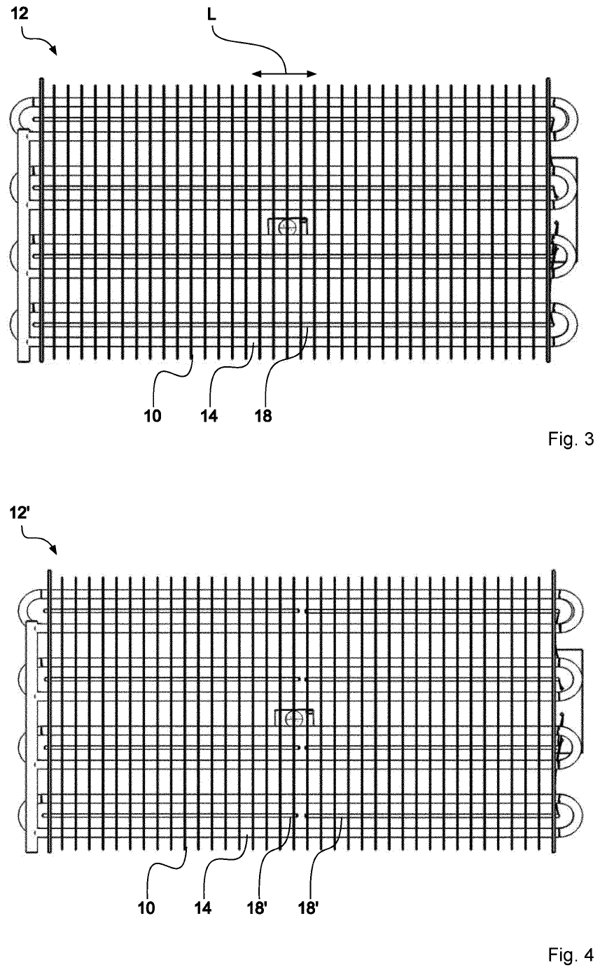

FIG. 3 shows the cooling fins 10 of the heat exchanger 12 with the heating rods 18 and the pipe 14. According to FIG. 3, the heating rods 18 completely penetrate the arrangement of the fins 10 along the longitudinal direction L over the entire length.

FIG. 4 shows an alternative design of a heat exchanger 12′, which can also be used in a device 2 according to the disclosure. The heat exchanger 12′ according to FIG. 4 differs from the heat exchanger 12 according to FIG. 3 in that heating rods 18′ are provided, which only penetrate the arrangement of fins 10 over a partial length when viewed along the longitudinal direction L.

As shown in FIG. 2, the device 2 has a device 20 for photographic imaging and a control device 22.

The device 20 for photographic imaging is a camera 20 which is set up both for photographic imaging in the visible wavelength range and for photographic imaging in the non-visible wavelength range and for this purpose has a sensor 24 for corresponding imaging in the said wavelength range.

The device 20 for photographic imaging is used to generate photographic images of the heat exchanger 12 and to transmit them to a control device 22 of the device 2. The control device 22 may have a computer for evaluating photographic images, may be connected to a computer for evaluating photographic images and/or may be connected to a server for evaluating photographic images.

The device 2 also has a temperature sensor 26, a pressure sensor 28 and a humidity sensor 30, which transmit signals to the control device 22.

The device 20 for photographic imaging, the temperature sensor 26, the pressure sensor 28 and the humidity sensor 30 are monitoring devices for monitoring the heat exchanger 12.

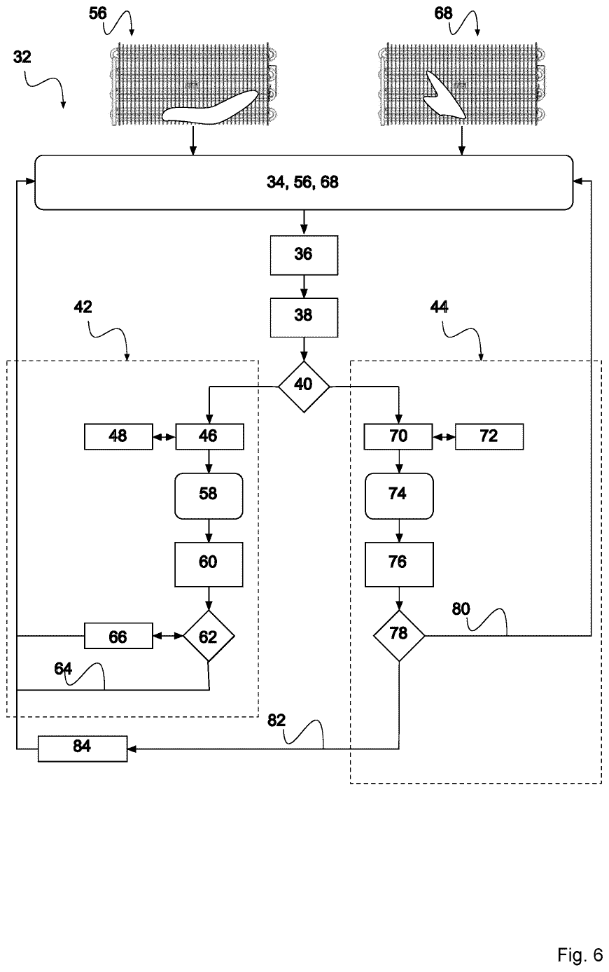

The control device is set up to carry out the method steps described below with reference to FIG. 6.

The flow diagram 32 according to FIG. 6 relates to the operation of the heat exchanger 12 of the device 2.

Block 34 of the flow diagram 32 describes the sensor level of the method and represents signals from the sensors 26, 28 and 30 as well as the provision of photographic images of the heat exchanger 12. Block 34 thus represents the input data of the method according to the disclosure, which is transmitted to a database 36.

This data is then processed or prepared in a further method step, which is represented by block 38.

According to step 40, it is checked whether the heating device 16 and/or the cleaning device 13 is switched on or whether a defrosting process and/or cleaning process is currently active. If the heating device 16 and/or the cleaning device 13 is not switched on and thus no defrosting process and/or cleaning process is active, the method branch 42 is carried out, which concerns a detection of the icing state and/or soiling state of the heat exchanger 12 and a determination of a defrosting time and/or cleaning time of the heat exchanger 12. If the heating device 16 and/or the cleaning device 13 is switched on and thus the defrosting process and/or cleaning process is active, the method branch 44 is carried out, which relates to controlling the defrosting process and/or the cleaning process.

First, the method steps of the method branch 42 are described.

In a method step 46, a photographic image of the heat exchanger 12 and/or sensor data from the sensors 26, 28, 30 are evaluated. The evaluation is carried out using software that is AI-based, namely an AI-based classifier.

The photographic image has been generated using the device 20 for photographic imaging.

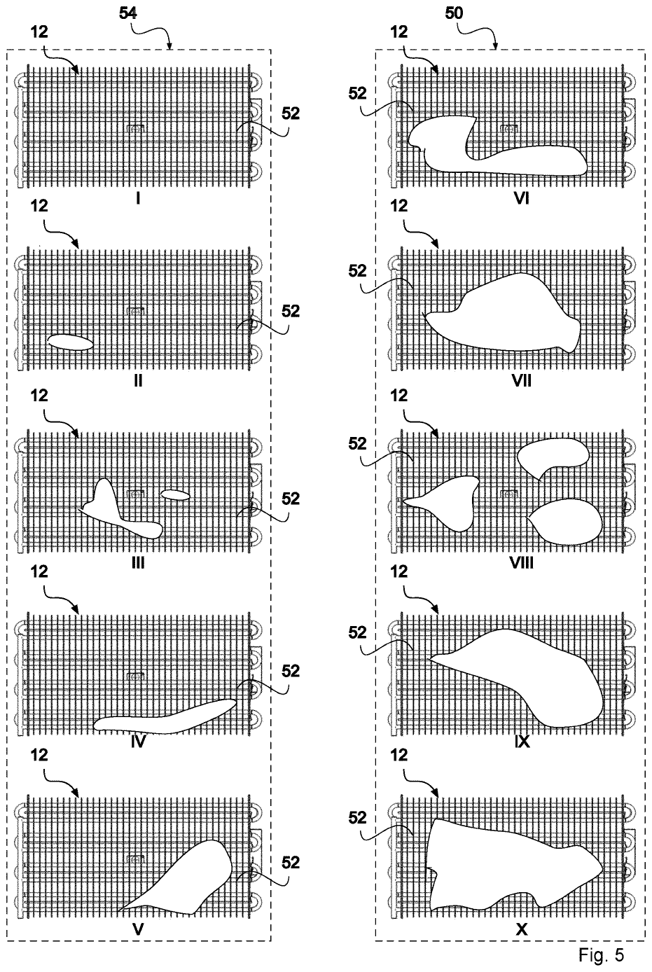

The AI model underlying the method steps 46 has been generated using training data represented by block 48. In particular, block 48 represents a machine learning, i.e. a statistical model, based on reference data manually evaluated and classified by specialized personnel. The AI model is therefore based on reference data and reference images in the form of photographic images, wherein the reference images are shown as an example in FIG. 5.

Here, a first group 50 shows reference images 52 for an icing condition and/or soiling condition of the heat exchanger 12 that requires defrosting and/or cleaning. Furthermore, a second group 54 shows reference images 52 for a state of icing and/or a state of soiling of the heat exchanger 12 which does not require defrosting and/or cleaning.

The reference images 52 of the heat exchanger 12 have been divided into ten classes according to the degree of icing and/or soiling to be recognized on the reference images 52, which are numbered consecutively from I-X in the present case, the degree of icing and/or soiling increasing with ascending numbering.

The reference images 52 with the degree of icing and/or soiling I, II, III, IV and V have been assigned to the second group 54, while the reference images with the degree of icing and/or soiling VI, VII, VIII, IX, X have been assigned to the first group 50.

An image 56 of the heat exchanger 12 according to FIG. 6 taken by means of the device 20 for photographic imaging is assigned to a class I-X in a process step 58 by means of the AI model 46 and it is determined on the basis of the assigned class In a process step 60 on the basis of the associated group 50, 54 whether or not defrosting and/or cleaning of the heat exchanger 12 is necessary.

If no defrosting and/or cleaning is required, the branch 42 restarts as a loop according to the path 64 starting from the branch 62.

If defrosting and/or cleaning is required, a defrosting time and/or cleaning time is determined according to the block or process step 66 in order to initialize the defrosting and/or cleaning. With the start of the defrosting process and/or cleaning process, the method branch 44 of the flow diagram 32 is therefore run through, since the query or condition 40 now leads to the method branch 44 due to the heating device 16 and/or cleaning device 13 being switched on.

The defrosting of the heat exchanger 12 is controlled by evaluating further photographic images 68 and/or sensor data from the sensors 26, 28, 30.

The evaluation of the further photographic images 68 is also based on an AI model 70 that has been generated on the basis of training data in a machine learning process according to the method step 72. In particular, the block 72 represents a machine learning, i.e. a statistical model, based on reference images manually evaluated and classified by skilled personnel.

With the method steps 74 and 76, analogous to the procedure described above with respect to the photographic images 56, the further photographic images 68 can be assigned to a class in order to stop the defrosting process depending on an icing condition of the heat exchanger 12.

If a cleaning process is triggered, this can be controlled based on time, for example, wherein the cleaning device is switched on for a predefined period of time.

If the assignment of the further photographic image 68 to a class indicates that defrosting is still required, the branch 44 is repeated according to the path 80. If the assignment of the further photographic image 68 to a class indicates that no further defrosting is required, the path 82 leads to the method step 84, which causes the heating device 16 to be switched off.

Due to the heating device 16 being switched off, the branch 42 is now run through again in a loop until a required defrosting and/or cleaning of the heat exchanger 12 is detected.

The signals from the sensors 26, 28, 30 can be used to check the plausibility of the image evaluation both during the detection of the icing state and/or soiling state and during the control of the defrosting process and/or the cleaning process.

It may be provided that the device 20 for photographic imaging is arranged inside the housing 4 according to an alternative design. In particular, it may be provided that the device 20 for photographic imaging is arranged within the housing 4 between the fans 8 and the heat exchanger 12.

It may be provided that the heat exchanger according to an alternative design is a so-called microchannel heat exchanger, which for example has parallel pipes for guiding a cooling medium and fins arranged in between.

The AI-based classifier 40 can be set up to determine a defrosting time and/or cleaning time for different heat exchangers, wherein the heat exchangers differ from one another in terms of their construction type and/or their operating conditions.

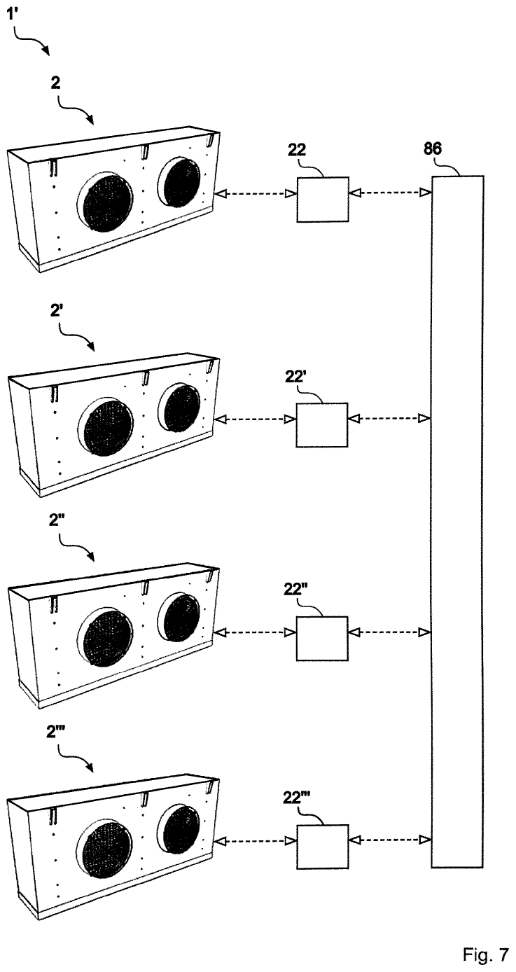

FIG. 7 shows a further system 1′ according to the disclosure, which has a plurality of devices 2, 2′, 2″, 2″′. The devices 2′, 2″, 2″′ have the same monitoring devices that have already been described with reference to device 2.

Each of the devices 2, 2′, 2″, 2″′ is connected with its assigned control unit to a server 86 which comprises reference data and/or the classifier 46, 70 for carrying out the method according to the disclosure.

The devices 2, 2′, 2″, 2″′ differ from one another in terms of their construction type and/or their ambient conditions. It is provided that the defrosting time and/or cleaning time of a respective heat exchanger of one of the respective devices 2, 2′, 2″, 2″′ for at least one degree of icing and/or degree of soiling is defined differently from the defrosting time and/or cleaning time of a heat exchanger of another of the respective devices 2, 2′, 2″, 2″′ for essentially the same degree of icing and/or degree of soiling.

This can be achieved, for example, in that the classes are numbered in ascending order to define an increasing degree of icing and/or soiling and/or an increasing defrosting and/or cleaning requirement, wherein a class is defined as a threshold for the heat exchanger of a respective device 2, 2′, 2″, 2″′, upon reaching or exceeding which a defrosting time and/or a cleaning time is defined, and a class is defined as a respective threshold for each respective heat exchanger of the various devices 2, 2′, 2″, 2″′, depending on their construction type and/or their ambient conditions, upon reaching or exceeding which a defrosting time and/or a cleaning time is defined, wherein the respective threshold is different for at least two of the respective different devices 2, 2′, 2″, 2″′.

Alternatively, this can be achieved in that the classes are assigned to groups, wherein a first group contains classes for whose degree of icing and/or degree of soiling there is a defrosting and/or cleaning requirement and wherein the second group contains classes for whose degree of icing and/or degree of soiling there is no defrosting and/or cleaning requirement, and in that for each of the respective different devices 2, 2′, 2″, 2″′ an assignment is made to the first group and to the second group as a function of its construction type and/or its ambient conditions, wherein the assignment of the classes to the first group and to the second group are different for at least two of the respective different devices 2, 2′, 2″, 2′″.

This means that the same database and the same AI-based evaluation can be used for the heat exchangers of all devices 2, 2′, 2″, 2′″.

The devices 2, 2′, 2″, 2′″ can be arranged spatially separated from each other or together in one room. In the event that the devices 2, 2′, 2″, 2″′ are arranged in one room, the software (AI) can shift a threshold of one or more devices 2, 2′, 2″, 2″′ for defrosting as required and/or adjust the assignment of the classes to the first or second group for one or more of the devices 2, 2′, 2″, 2″′ and/or prioritize defrosting based on the degree of icing.

In this way, a defrosting sequence can be defined, wherein in particular no simultaneous defrosting of devices 2, 2′, 2″, 2″′ or their heat exchangers arranged together in one room takes place.

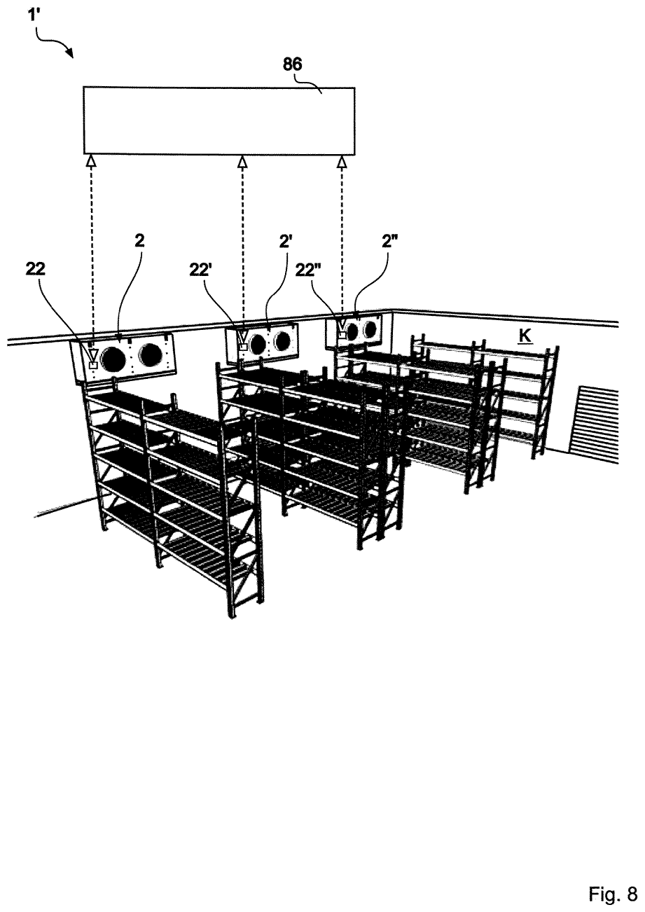

FIG. 8 shows the system 1′ from FIG. 7 in a cold room K. Only three devices 2, 2′, 2″ are shown.

For the system according to FIG. 7, it is provided that a defrosting time of a respective heat exchanger of a respective device 2, 2′, 2″ is determined in an AI-based manner by means of the AI-based classifier, wherein a defrosting sequence is determined by means of the AI, so that defrosting of the heat exchangers of the devices 2, 2′, 2″ does not take place simultaneously.

For this purpose, it is provided that the defrosting sequence of the heat exchangers of the devices 2, 2′, 2″ is carried out by an AI-based determination of a respective class (I-X) as a threshold for each of the heat exchangers of the devices 2, 2′, 2″, with the reaching or exceeding of which a defrosting time is determined.

In the present case, identical heat exchangers of the devices 2, 2′, 2″ are arranged together in the walk-in cold room K. For each of the heat exchangers of the devices 2, 2′, 2″, class VI is defined as the threshold at which defrosting is initiated. For one of the heat exchanger devices 2, 2′, 2″, the threshold is lowered from class VI to class IV by means of the AI in order to defrost this heat exchanger first. The lowering of the threshold is then repeated for each of the heat exchangers of devices 2, 2′, 2″. After defrosting, the threshold of the respective heat exchanger of the devices 2, 2′, 2″ can be reset to the original value (class VI).

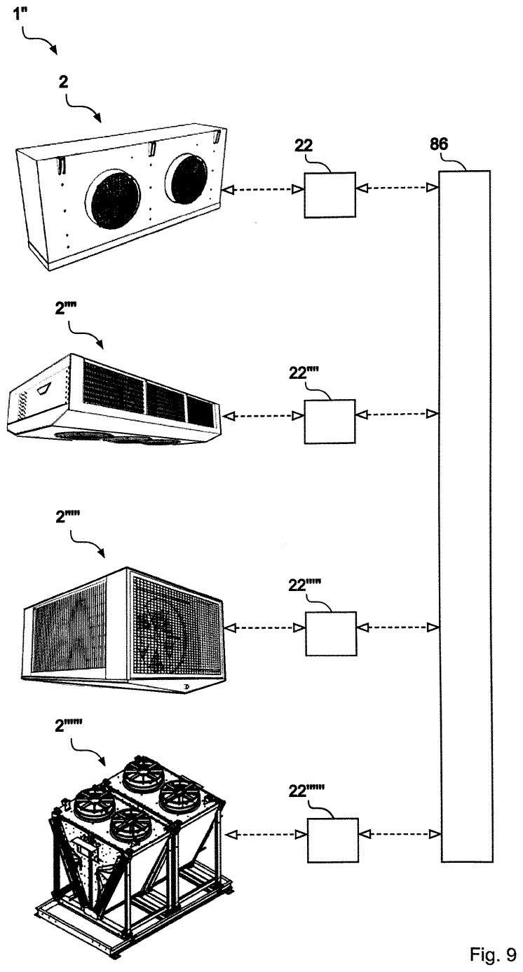

FIG. 9 a further system 1″ according to the disclosure with a plurality of devices 2, 2″″, 2″″′, 2″″′ and a server 86. The method according to the disclosure can be used for devices with heat exchangers of different construction types, wherein a threshold for defrosting and/or cleaning can be defined individually for each of the devices 2, 2″″, 2″″′, 2″″′ or an assignment of the classes to the first or second group can be defined. The devices 2, 2″″, 2″″′, 2″″′ can be designed for indoor or outdoor use. The devices 2, 2″″, 2″″′, 2″″′ can be condensers, evaporators, recoolers or the like of cooling systems and/or heating systems or can be used in heating technology and/or cooling technology.

1. A method for operating a heat exchanger the method including the following steps:
operating a heat exchanger;
monitoring of the heat exchanger by at least one monitoring device, such as a sensor, a device for imaging;
detecting a degree of icing and/or a degree of soiling of the heat exchanger and determining a defrosting time and/or a cleaning time of the heat exchanger by evaluating data from the at least one monitoring device;
wherein the evaluation of the data is AI-based,
wherein an AI-based classifier has two or more classes defining a degree of icing and/or a degree of soiling, and
wherein the AI-based classifier assigns the data of the at least one monitoring device to one of the classes,
wherein
the classes define an increasing degree of icing and/or degree of soiling in ascending order of numbering and/or define an increasing defrosting and/or cleaning requirement, wherein a class is defined as a threshold for the heat exchanger, upon reaching or exceeding which a defrosting time and/or a cleaning time is defined, and/or
the classes are assigned to groups, wherein a first group contains classes for whose degree of icing and/or degree of soiling there is a defrosting and/or cleaning requirement and wherein the second group contains classes for whose degree of icing and/or degree of soiling there is no defrosting and/or cleaning requirement.

2. The method according to claim 1,
wherein
the AI-based classifier is set up to determine a defrosting time and/or
cleaning time for different heat exchangers, wherein the heat exchangers differ from one another in terms of their construction type and/or their operating conditions.

3. The method according to claim 2,
wherein
for each of the respective different heat exchangers, depending on its construction type and/or its ambient conditions, a class is defined as a respective threshold, upon reaching or exceeding which a defrosting time and/or a cleaning time is defined, wherein the respective threshold is different for at least two of the respective different heat exchangers
and/or
for each of the respective different heat exchangers, the classes are assigned to the first group and to the second group as depending on their construction type, wherein the assignment of the classes to the first group and to the second group is different for at least two of the respective different heat exchangers.

4. The method according to claim 2,
whereby
operating a further heat exchanger;
monitoring of the further heat exchanger by at least one further monitoring device, such as a sensor, a device for imaging;
detecting a degree of icing and/or degree of soiling of the further heat exchanger and determining a defrosting time and/or cleaning time of the further heat exchanger by evaluating data from the at least one further monitoring device;
wherein the evaluation of the data is AI-based by the AI-based classifier,
wherein the AI-based classifier assigns the data of the at least one further monitoring device to one of the classes, and
wherein the defrosting time and/or cleaning time of the heat exchanger for at least one degree of icing and/or degree of soiling is defined differently from the defrosting time and/or cleaning time of the further heat exchanger with essentially the same degree of icing and/or degree of soiling.

5. The method according to claim 4,
wherein
the same database and the same AI-based evaluation are used for both the beat exchanger and the further heat exchanger
and/or
a plurality of heat exchangers are provided, wherein a defrosting time and/or cleaning time is determined AI-based by the AI-based classifier for each of the plurality of heat exchangers depending on its respective construction type and/or its respective operating conditions.

6. The method according to claim 1,
wherein
manually classified reference data can be used as training data for the AI-based classifier
and/or
exactly five classes are provided, wherein three classes are assigned to the first group and two classes are assigned to the second group
and/or
the first group has more classes than the second group
and/or
each of the groups has fewer than five classes.

7. The method according to claim 1,
wherein
a control device of the heat exchanger is connected to a server,
wherein the AI-based classifier and/or a database of the AI-based classifier are stored on the server.

8. The method according to claim 1.
wherein
two or more heat exchangers are provided,
wherein a defrosting time and/or cleaning time is determined AI-based by the AI-based classifier for each of the two or more heat exchangers depending on its respective construction type and/or its respective operating conditions, and
wherein a defrosting sequence and/or cleaning sequence is determined on the basis of the construction type and/or the operating conditions and/or on the basis of a degree of icing and/or a degree of soiling of a respective heat exchanger of the two or more heat exchangers, wherein
the two or more heat exchangers are arranged in a walk-in cold room and defrosting of the heat exchangers takes place essentially one after the other, essentially not simultaneously and/or
a defrosting sequence and/or cleaning sequence of the heat exchangers is carried out by an AI-based determination of a respective class as a threshold for each of the heat exchangers, upon reaching or exceeding which a defrosting time and/or a cleaning time is determined and/or
a defrosting sequence and/or cleaning sequence of the heat exchangers is carried out by AI-based assignment of a respective class to the first or second group for each of the heat exchangers.

9. A system comprising:
a device,
wherein the device (2, 2′, 2″, 2″′, 2″″, 2″″′, 2″″′) has a heat exchanger with a heating device and/or with a cleaning device,
wherein the device comprises a control device and at least one monitoring device, such as a sensor, a device for imaging, for monitoring the heat exchanger,
having an AI-based classifier,
wherein the control device is set up to perform the following method steps:
operating the heat exchanger;
monitoring of the heat exchanger by the at least one monitoring device;
detecting a degree of icing and/or a degree of soiling of the heat exchanger and determining a defrosting time and/or a cleaning time of the heat exchanger by evaluating data from the at least one monitoring device;
wherein the evaluation of the data is AI-based,
wherein an AI-based classifier has two or more classes that define a degree of icing and/or a degree of soiling, and
wherein the AI-based classifier assigns the data of the at least one monitoring device to one of the classes.

10. The system according to claim 9,
wherein
the AI-based classifier is set up to determine a defrosting time and/or cleaning time for different heat exchangers, wherein the heat exchangers differ from one another in terms of their construction type and/or their operating conditions.

11. The system according to claim 10,
wherein
the system has a further device,
wherein the further device has a further heat exchanger with a further heating device and/or with a further cleaning device,
wherein the further device has a further control device and at least one further monitoring device, such as a sensor, a device for imaging, for monitoring the further heat exchanger,
wherein the further control device is set up to carry out the following method steps:
operating the further heat exchanger;
monitoring of the further heat exchanger by the at least one further monitoring device;
detecting a degree of icing and/or degree of soiling of the further heat exchanger and determining a defrosting time and/or cleaning time of the further heat exchanger by evaluating data from the at least one further monitoring device;
wherein the evaluation of the data is AI-based,
wherein the AI-based classifier assigns the data of the at least one further monitoring device to one of the classes,
wherein both the control device of the heat exchanger of the device and the further control device of the further heat exchanger of the further device are connected to a server,
wherein the AI-based classifier and/or a database of the AI-based classifier is stored on the server.

12. The system according to claim 11,
wherein
the same database and the same AI-based evaluation are used both for the beat exchanger of the device and for the heat exchanger of the further device.

13. The system according to claim 11,
wherein
the defrosting time and/or cleaning time of the heat exchanger for at least one degree of icing and/or degree of soiling is defined differently from the defrosting time and/or cleaning time of the further heat exchanger for essentially the same degree of icing and/or degree of soiling.

14. The system according to claim 9,
wherein
manually classified reference data serve as the basis for the AI-based classifier.

15. The system according to claim 9,
wherein
a plurality of devices may be provided,
wherein a defrosting time and/or cleaning time is determined AI-based by the AI-based classifier (40, 76) for each of the plurality of devices.

16. The system according to claim 9,
wherein
the system is set up to carry out a method for one heat exchanger or for a plurality of heat exchangers, the method including the following steps:
operating a heat exchanger;
monitoring of the heat exchanger by at least one monitoring device, such as a sensor, a device for imaging;
detecting a degree of icing and/or a degree of soiling of the heat exchanger and determining a defrosting time and/or a cleaning time of the heat exchanger by evaluating data from the at least one monitoring device;
wherein the evaluation of the data is AI-based,
wherein an AI-based classifier has two or more classes defining a degree of icing and/or a degree of soiling, and
wherein the AI-based classifier assigns the data of the at least one monitoring device to one of the classes,
wherein
the classes define an increasing degree of icing and/or degree of soiling in ascending order of numbering and/or define an increasing defrosting and/or cleaning requirement, wherein a class is defined as a threshold for the heat exchanger, upon reaching or exceeding which a defrosting time and/or a cleaning time is defined, and/or
the classes are assigned to groups, wherein a first group contains classes for whose degree of icing and/or degree of soiling there is a defrosting and/or cleaning requirement and wherein the second group contains classes for whose degree of icing and/or degree of soiling there is no defrosting and/or cleaning requirement
